(19) United States
(12) Patent Application Publication
(10) Pub. No.: US 2016/0190628 A1
(43) Pub. Date: Jun. 30, 2016

(54) LAMINAR FLOW BATTERY

(71) Applicant: EDEN RESEARCH AND DEVELOPMENT PTY LTD, Victoria (AU)

(72) Inventor: Robert Percy YOUNG, Victoria (AU)

(21) Appl. No.: 14/392,230

(22) PCT Filed: Jun. 27, 2014
(86) PCT No.: PCT/AU2014/000666

§ 371 Date: Dec. 23, 2015

(30) Foreign Application Priority Data
Jun. 27, 2013 (AU) 2013902370

(51) Int. Cl. H01M 8/18; H01M 8/20; H01M 8/00; H01M 8/04276

(52) U.S. Cl. CPC H01M 8/188; H01M 8/04276; H01M 8/20; H01M 8/006; H01M 2250/20

(57) ABSTRACT

An electrochemical cell is disclosed. The cell comprises a substrate with an elongate channel formed therein; first and second electrodes extending longitudinally in the channel and disposed to opposite sides of the channel; and three fluid ports at each end of the channel for ingress and egress of respective fluids, wherein three fluids entering into the channel through respective fluid ports at one end flow through the channel in parallel laminar streams and exit the channel through the respective ports at the other end. One of the fluids is disposed between the other two fluids in the channel, and facilitates diffusion of ions to and from those other two fluids. One or more of the cells may be used as part of a flow battery. Also described is a method for manufacturing the electrochemical cell. The battery may be used to power an electric vehicle.

### FIELD OF THE INVENTION

This invention relates to a flow battery and an electrochemical cell used therein, in which a plurality of fluid reagents undergo laminar flow in a common channel provided with electrodes so as to generate a potential difference therebetween. In a particular embodiment, the plurality of fluid reagents comprises a neutralyte or capacitor fluid comprising one or more metal oxide nano-particles.

### BACKGROUND TO THE INVENTION

A flow battery is an electrochemical device that converts the chemical energy of the electroactive materials directly to electrical energy. The electroactive materials in a flow battery are stored mostly externally and are introduced into the device (e.g. reaction chamber containing electrodes) only during operation. Most redox (reduction-oxidation) flow batteries consist of two separate electrolytes, one storing the electroactive materials for the negative electrode reactions and the other for the positive electrode reactions. To prevent confusion, the negative electrode is the anode and the positive electrode is the cathode during discharge. It is to be noted, however, that these names will be reversed during charge, while the polarity of the electrodes, negative/positive, remains unchanged.

With the electrolyte and electroactive materials stored externally, flow batteries have many advantages, one of which is the separation of the power and energy requirements. The energy-capacity requirement of a flow battery is determined by the size of the external storage components, whereas the power is determined by the size and characteristics of the reaction chamber. A good analogy is an internal combustion engine system, wherein the power is determined by the size of the engine whilst the energy capacity is determined by the size of the fuel tank. The electrodes in a flow battery do not undergo physical and chemical changes during operation, thus leading to more stable and durable performance and longer life times, reducing the cost of the energy-storage device. Redox flow batteries can also operate over a greater state-of-charge range which means that a smaller quantity of electro-active material may be required to deliver power over the entire required duration of discharge.

### SUMMARY OF THE INVENTION

The present invention is directed to an electrochemical cell and a flow battery comprising a plurality of fluid reagents. The fluid reagents undergo laminar flow in a common channel provided with electrodes so as to generate an electric potential difference. The plurality of fluid reagents may comprise a neutralyte or capacitor fluid. The neutralyte may comprise one or more metal oxide nano-particles. The neutralyte fluid stream may be in contact with both an anolyte fluid stream and a catholyte fluid stream.

In a first aspect, the present invention provides an electrochemical cell comprising:

a substrate with an elongate channel formed therein;

first and second electrodes extending longitudinally in the channel and disposed along or adjacent opposite sides of the channel; and

three fluid ports at each end of the channel for ingress and egress of respective fluids, wherein three fluids entering into the channel through respective fluid ports at one end flow through the channel in parallel laminar streams and exit the channel through the respective ports at the other end.

In one embodiment of the first aspect, two of the three fluids, in use, comprise electrolytes containing electro-active ions that undergo reactions in the vicinity of the electrodes.

In another embodiment of the first aspect, the third fluid, in use, is disposed between the other two fluids in the channel, and facilitates diffusion of ions to and from the other two fluids.

In yet another embodiment of the first aspect, the third fluid comprises a neutralyte. The neutralyte may comprise one or more metal oxide nano-particles. In particular embodiments, the neutralyte comprises one or more of antimony oxide nano-particles; mercury oxide nano-particles; lead oxide nano-particles and/or silver oxide nano-particles. In a further particular embodiment, the neutralyte comprises antimony oxide nano-particles. The antimony oxide nano-particles may comprise one or more of diantimony tetroxide nano-particles; antimony trioxide nano-particles; and/or antimony pentoxide nano-particles.

In still another embodiment of the first aspect, the third fluid comprises a colloidal suspension of the one or more metal oxide nano-particles. The colloidal suspension may comprise a solid phase comprising the one or more metal oxide nano-particles and a solution phase. The solution phase may comprise one or more solvents. The one or more solvents may comprise one or more polar solvents. In a particular embodiment, the one or more solvents comprises water. Preferably, the water comprises deionised water.

In one embodiment of the first aspect, the one or more metal oxide nano-particles comprise a particle size range of between 10 micrometers and 1 nanometers. In a preferred embodiment, the particle size range comprises between 1 micrometer and 10 nanometers.

In another embodiment of the first aspect, the one or more metal oxide nano-particles comprise a spherical or substantially spherical shape with a peachoid cleft on the surface.

In yet another embodiment of the first aspect, the one or more metal oxide nano-particles may comprise vitrified nano-particles of the one or more metal oxide.

In a second aspect, the invention provides a flow battery comprising:

at least one electrochemical cell comprising:
a substrate with an elongate channel formed therein;
first and second electrodes extending longitudinally in the channel and disposed along or adjacent opposite sides of the channel;
three fluid ports at each end of the channel for ingress and egress of respective fluids, wherein three fluids entering into the channel through respective fluid ports at one end flow through the channel in parallel laminar streams and exit the channel through the respective ports at the other end;

three fluid reservoirs coupled to the respective ports at one end of the channel to provide fluids thereto; and

at least one fluid motivator arranged to drive fluids from the reservoirs into the channel through the respective ports.

According to one embodiment of the second aspect, two of the three fluids may, in use, comprise electrolytes containing electro-active ions that undergo reactions in the vicinity of the electrodes.

According to another embodiment of the second aspect, the third fluid which, in use, is disposed between the other two fluids in the channel, facilitates diffusion of ions to and from the other two fluids.

According to yet another embodiment of the second aspect, the third fluid may comprise a neutralyte. The neutralyte may comprise one or more metal oxide nano-particles. In particular embodiments, the third fluid comprises one or more of antimony oxide nano-particles; mercury oxide nano-particles; lead oxide nano-particles and/or silver oxide nano-particles. In a further particular embodiment, the neutralyte comprises antimony oxide nano-particles. The antimony oxide nano-particles may comprise one or more of diantimony tetroxide nano-particles; antimony trioxide nano-particles; and/or antimony pentoxide nano-particles.

According to one embodiment of the second aspect, the third fluid comprises a colloid suspension of the one or more metal oxide nano-particles. The colloid suspension may comprise a solid phase comprising the one or more metal oxide nano-particles and a solution phase. The solution phase may comprise one or more solvents. The one or more solvents may comprise one or more polar solvents. In particular embodiments the one or more solvents comprises water. Preferably, the water comprises deionised water.

According to another embodiment of the second aspect, the one or more metal oxide nano-particles comprise a particle size range between 10 micrometers and 1 nanometer. In a preferred embodiment, the particle size is between 1 micrometer and 10 nanometers.

According to yet another embodiment of the second aspect, the one or more nano-particles comprise a spherical or substantially spherical shape with a peachoid cleft on the surface.

According to still another embodiment of the second aspect, the one or more metal oxide nano-particles comprise vitrified nano-particles.

In one embodiment, the flow battery of the second aspect comprises a plurality of electrochemical cells coupled to the fluid reservoirs in a parallel arrangement.

In another embodiment, the flow battery of the second aspect comprises electrical conductors that couple the respective electrodes of the cells in series and/or parallel circuits.

In a particular embodiment, the flow battery of the second aspect comprises an electric vehicle battery and may be used to power an electric vehicle.

In a third aspect, the invention provides a method for manufacturing an electrochemical cell comprising:

providing a substrate with an elongate channel formed therein;

extending first and second electrodes longitudinally in or adjacent the channel so as to be disposed along opposite sides of the channel; and

providing three fluid ports at each end of the channel for ingress and egress of respective fluids, wherein three fluids entering into the channel through respective fluid ports at one end flow through the channel in parallel laminar streams and exit the channel through the respective ports at the other end.

In one embodiment of the third aspect, two of the three fluids comprises electrolytes comprising electro-active ions that undergo reactions in the vicinity of the electrodes.

In another embodiment of the third aspect, the third fluid is disposed between the other two fluids in the channel.

In yet another embodiment of the third aspect, the third fluid may facilitate diffusion of ions to and from the other two fluids.

In still another embodiment of the third aspect, the third fluid comprises a neutralyte. The neutralyte may comprise one or more metal oxide nano-particles. In particular embodiments the neutralyte comprises one or more of antimony oxide nano-particles; mercury oxide nano-particles; lead oxide nano-particles and/or silver oxide nano-particles. In a further particular embodiment, the neutralyte comprises antimony oxide nano-particles. The antimony oxide nano-particles may comprise one or more of diantimony tetroxide nano-particles; antimony trioxide nano-particles; and/or antimony pentoxide nano-particles.

In another embodiment of the third aspect, the third fluid may comprise a colloidal suspension of the one or more metal oxide nano-particles. The colloid suspension may comprise a solid phase comprising the one or more metal oxide nano-particles and a solution phase. The solution phase may comprise one or more solvents. The one or more solvents may comprise one or more polar solvents. In a particular embodiment the one or more solvents comprises water. Preferably, the water comprises deionised water.

In yet another embodiment of the third aspect, the one or more metal oxide nano-particles comprise a particle size range of between 10 micrometers and 1 nanometer. In a preferred embodiment, the particle size range comprises between 1 micrometer and 10 nanometers. In still another embodiment of the third aspect, the one or more metal oxide nano-particles comprise a spherical or substantially spherical shape with a peachoid cleft on the surface.

In another embodiment of the third aspect, the one or more metal oxide nano-particles may comprise vitrified nano-particles of the one or more metal oxide.

In a fourth aspect, the invention provides an electric vehicle comprising one or more flow batteries according to the second aspect.

In a fifth aspect, the invention provides a method of powering an electric vehicle comprising:

providing one or more flow batteries according to the second embodiment to thereby provide the power for an electric vehicle.

In a sixth aspect, the invention provides a method for assembling an electric vehicle and an electric power source comprising:

inserting one or more flow batteries according to the second aspect into the electric vehicle to thereby provide the electric power source and assemble the electric vehicle.

### BRIEF DESCRIPTION OF THE FIGURES

In order that the present invention may be readily understood and put into practical effect, reference will now be made to the accompanying illustrations, wherein like reference numerals refer to like features and wherein:

FIG. 1 is a schematic diagram of a prior art flow battery utilising an ion-selective membrane;

FIG. 2 is a schematic diagram of a flow battery according to one embodiment of the invention having three fluids in laminar flow;

FIG. 3 is a diagrammatic illustration of a laminar flow electrochemical cell according to one embodiment of the invention;

FIG. 4a is a plan view of a laminar flow electrochemical cell according to one embodiment of the invention;

FIG. 4b is a close up view of the area indicated with the box drawn in dashed lines in FIG. 4a.

FIGS. 5 and 6 are perspective views of a laminar flow electrochemical cell according to one embodiment of the invention;

FIG. 7 is a perspective view of the electrochemical cell according to one embodiment of the invention illustrating fluid flows therein;

FIGS. 8 and 9 are plan and end views, respectively, of the electrochemical cell of FIG. 7;

FIGS. 10, 11 and 12 illustrate a plurality of electrochemical cells arranged in an array according to one embodiment of the invention.

FIG. 13 is a photo of an electrochemical cell constructed according to one embodiment of the invention.

### DETAILED DESCRIPTION OF THE INVENTION

The present invention relates to an electrochemical cell and a flow battery comprising a plurality of fluid reagents. The fluid reagents undergo laminar flow in a common channel provided with electrodes so as to generate an electric potential difference. Preferably, one of the fluid reagents comprises a neutralyte. The neutralyte may comprise one or more metal oxide nano-particles. The neutralyte fluid stream may be in contact with both an anolyte fluid stream and a catholyte fluid stream.

In particular embodiments, the electrochemical cell and flow battery of the invention may be of lighter weight and smaller size than conventional batteries of similar capacity.

Through diligent study the inventor has realised that a neutralyte fluid in contact with both an anolyte fluid and a catholyte fluid may be used to provide an improved battery.

In particular aspects, the invention contemplates the use of a neutralyte comprising one or more metal oxide nano-particles.

Herein, the term “neutralyte” means a substance, preferably a fluid, that facilitates diffusion of ions to and from other fluids or between other fluids. In one particular embodiment the neutralyte comprises a colloid or colloidal suspension comprising one or more metal oxide nano-particles. The solid phase of the colloid suspension comprises the metal oxide nano-particles, while the solution phase comprises any suitable solvent. The inventors' trials have shown that the neutralyte may comprise nano-particles comprising any metal oxide. The neutralyte itself may comprise a charged state or transition between a neutral and charged state and the connotation of “neutral” is towards the exchange of ions between the other fluids summing to a neutral charge or a substantially neutral charge to achieve an electrical balance. As such, the neturalyte may comprise one or more electrolytes.

The neutralyte may act as a form of chemical capacitor, in that it absorbs and supplies, or appears to absorb and supply, ions across the laminar fluid interfaces as required. Accordingly, the neutralyte may be referred to as a capacitor fluid.

Where the terms “comprise”, comprises”, “comprising”, “include”, “includes”, “included” or “including” are used in this specification, they are to be interpreted as specifying the presence of the stated features, integers, steps or components referred to, but not to preclude the presence or addition of one or more other features, integers, steps, components or group thereof.

Further, any prior art reference or statement provided in the specification is not to be taken as an admission that such art constitutes, or is to be understood as constituting, part of the common general knowledge.

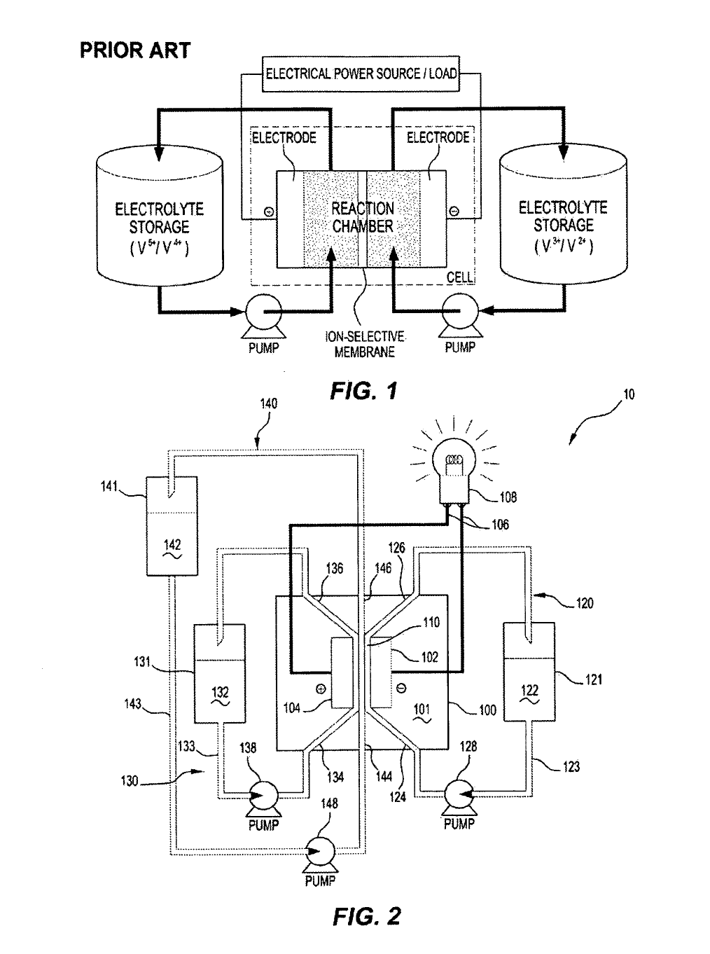

An example of a prior art redox flow battery is illustrated diagrammatically in FIG. 1, in this case utilising different oxidation states of vanadium in both electrolyte fluids. The electrolyte in the positive half-cell contains VO²⁺ and VO₂⁺ ions (corresponding to oxidation states V⁴⁺ and V⁵⁺, respectively), and the electrolyte in the negative half-cell contains V³⁺ and V²⁺ ions. Storage tanks hold reserves of the two electrolytes which are pumped on demand into the two reaction chamber cells. The two half-cells are separated by an ion exchange membrane that prevents the different electrolytes from mixing. When the vanadium battery is charged, the VO²⁺ ions in the positive half-cell are converted to VO₂⁺ ions when electrons are removed from the positive electrode of the cell. Similarly in the negative half-cell, electrons are introduced at the electrode converting the V³⁺ ions into V²⁺. The electrical circuit is completed by the ion exchange membrane which allows positively-charged hydrogen ions (protons) to pass through from one electrolyte to the other. During the battery discharge cycle this process is reversed and results in a typical open-circuit voltage of 1.25 V at 25° C.

A flow battery 10 utilising three laminar flow fluid streams in an electrochemical cell 100 is illustrated in FIG. 2. Cell 100 includes a substrate 101 with electrodes 102, 104 therein and an elongate channel 110 formed between electrodes 102, 104. At one end of cell 100, fluid inlet ports 124, 134, 144 are formed in substrate 101 leading to one end of channel 110, and at the other end of cell 100, fluid outlet ports 126, 136, 146 are formed in like fashion. Inlet ports 124, 134, 144, outlet ports 126, 136, 146 and channel 110 are carefully arranged so that three fluids 122, 132, 142 introduced to cell 100 through respective inlet ports 124, 134, 144 can undergo side-by-side laminar flow along the length of channel 110, to the respective outlet ports 126, 136, 146. For example, fluid 122 introduced at inlet port 124, flows through channel 110, adjacent to electrode 102, and into outlet port 126, whilst fluid 132 introduced at inlet port 134, flows through channel 110, adjacent to electrode 104, and into outlet port 136.

Fluid 142, comprising a neutralyte, introduced to the cell through inlet port 144, flows through channel 110, between the other two laminar fluid streams and into outlet port 146.

Whilst 124, 134, 144 have been designated inlet ports and 126, 136, 146 outlet ports, cell 100 is generally symmetrical so that fluid flows through ports 124, 126, 134, 136, 144, 146 and channel 110 can be achieved equally in either direction. In other words, fluids 122, 132, 142 can also undergo laminar flow from outlet ports 126, 136, 146 through channel 110 to inlet ports 124, 134, 144.

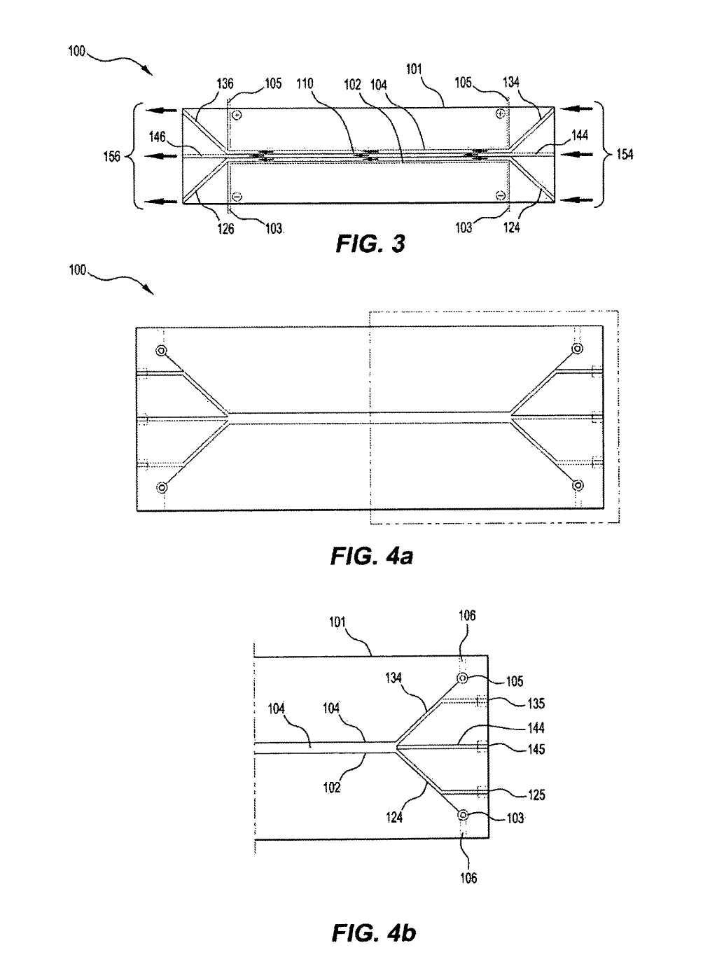

Electrodes 102, 104 are elongate and parallel, extending along the length of channel 110 and disposed to respective sides thereof, as shown in FIG. 3. The width of channel 110 can be defined by the space between the parallel faces of electrodes 102, 104. The length of channel 110 corresponds to the length of the space between the two electrodes 102, 104 in which three fluid streams can flow, which is defined by the parallel extent of the electrodes and the convergence of inlet 124, 134, 144 and outlet 126, 136, 146 ports into channel 110.

FIG. 3 shows positive terminals 105 and negative terminals 103 of the negative 102 and positive 104 electrodes. A person of skill in the art readily understands how to both connect these terminals 103, 105 to a device to be powered by cell 100 and how to connect these terminals 103, 105 to one or more other similar terminals 103, 105 on one or more other cells 100 to construct a battery 100 for powering an electric device.

The corresponding pairs of inlet ports 124, 134, 144 and outlet ports 126, 136, 146 are each connected to a respective fluid circuit 120, 130, 140. As shown in FIG. 2, inlet port 124 and outlet port 126 are connected to fluid circuit 120, inlet port 134 and outlet port 136 are connected to fluid circuit 130, and inlet port 144 and outlet port 146 are connected to fluid circuit 140. Each fluid circuit includes a fluid reservoir 121, 131, 141 coupled to the inlet ports 124, 134, 144 and outlet ports 126, 136, 146 by way of respective fluid conduits 123, 133, 143.

Fluids 122, 132, 142 are motivated through circuits 120, 130, 140 by way of pumps 128, 138, 148. In other embodiments, a single pump is used to drive fluid flow in all three circuits 120, 130, 140.

Fluid circuits 120, 130 contain a negative electrolyte fluid 122 and a positive electrolyte fluid 132, respectively. Fluid circuit 140 contains another electrolyte fluid, the neutralyte fluid 142. The fluids 122, 132, 142, are referred to in the drawing as anolyte, catholyte and neutralyte, respectively. This terminology is most appropriate while the battery is discharging, wherein the negative electrode 102 is the anode and the positive electrode 104 is the cathode.

Fluids 122, 132, 142, in use, circulate in fluid circuits 120, 130, 140 through cell 100, motivated by pumps 128, 138, 148. When flowing through channel 110, anolyte fluid 122 is in contact with negative electrode 102 on one side and the neutralyte 142 fluid stream on the other. Similarly, the catholyte fluid 132 stream in channel 110 has positive electrode 104 on one side and neutralyte fluid 142 stream on the other. The neutralyte fluid 142 stream in channel 110 is therefore in contact with anolyte fluid 122 on one side and catholyte fluid 132 on the other.

Electrodes 102, 104 are, in use, connected in an electrical circuit through electrical conductors 106. When flow battery 10 is in a discharge cycle, described below, conductors 106 may be connected to electrical load 108 as shown in FIG. 2. Conversely, the flow battery 10 is in a charging cycle, load 108 may be replaced by a source of electricity, such as a generator, a connection to a power grid, a designated charge point or the like. In a particular embodiment when flow battery 10 is used to power an electric vehicle, the source of electricity may comprise a public or private charge point.

Negative electrolyte fluid 122 may comprise electro-active chemicals such as, redox couple ions to undergo a negative half-cell reaction in the vicinity of the negative electrode 102, whilst positive electrolyte fluid 132 may comprise electro-active chemicals such as, redox couple ions to undergo a positive half-cell reaction in the vicinity of positive electrode 104. Electrical balance is achieved through the neutralyte 142 that is located centrally of the anolyte 122 and catholyte 132 in channel 110 and that functions to diffuse ions to and from positive 132 and negative 122 electrolyte fluids in channel 110 of electrochemical cell 100.

Using the chemistry of a vanadium flow battery as an example, negative electrolyte fluid 122 may comprise a solution of V²⁺/V³⁺ ions, and positive electrolyte fluid 132 may comprise a solution of V⁴⁺/V⁵⁺ ions. For example, the electrolytes can be formed from vanadium sulphates in sulphuric acid solutions, although other combinations are possible such as vanadium chlorides and hydrochloric acid. In the case of a vanadium redox battery the following half-cell reactions are involved to produce a standard voltage of about 1.25 V between the electrodes.

At negative electrode 102, vanadium (III) cations are transformed to vanadium (II) cations:

Charge V³⁺+e⁻→V²⁺(E^{o}=−0.25 V)

Discharge V³⁺+e⁻←V²⁺

At positive electrode 104, vanadium (IV) ions are transformed to vanadium (V) ions:

Charge VO²⁺+H₂O−e⁻→VO²⁺+2H⁺(E^{o}=1.00 V)

Dishcharge VO²⁺+H₂O−e⁻←VO²⁺+2H⁺

When battery 10 is operating in a discharge cycle fluids 122, 132, 142 are pumped into the ports 124, 134, 144, through channel 110 and out of cell 100 through outlet ports 126, 136, 146. Whilst in cell reaction channel 110 the redox half-cell reactions take place in the vicinity of electrodes 102, 104 which donate and take up electrons from the negative 122 and positive 132 electrolyte solutions, respectively. While not wanting to be bound by any one theory, the inventor believes electrical balance is provided through the neutralyte fluid 142, which allows hydrogen ions (protons) to diffuse across the laminar flow boundaries between the fluids in channel 110. While not wanting to be bound by any one theory, the inventor hypothesises that the neutralyte fluid 142 facilitates diffusion of ions to and from fluids 122, 132 or between other fluids 122, 132. As a result of the reactions, a potential difference is created between the two electrodes 102, 104 that can be used to power an electrical load 108 connected thereto by conductors 106.

When the battery 10 is operating in a charging cycle, the direction of fluid flows through cell 100 is reversed, whereby fluids 122, 132, 142 enter cell 100 through outlet ports 126, 136, 146 and leave through inlet ports 124, 134, 144. In this case an external source (not shown) is used to apply a potential difference to electrodes 102, 104, preferably somewhat higher than the cell reaction potential, to drive the half-cell reactions the other way as outlined above.

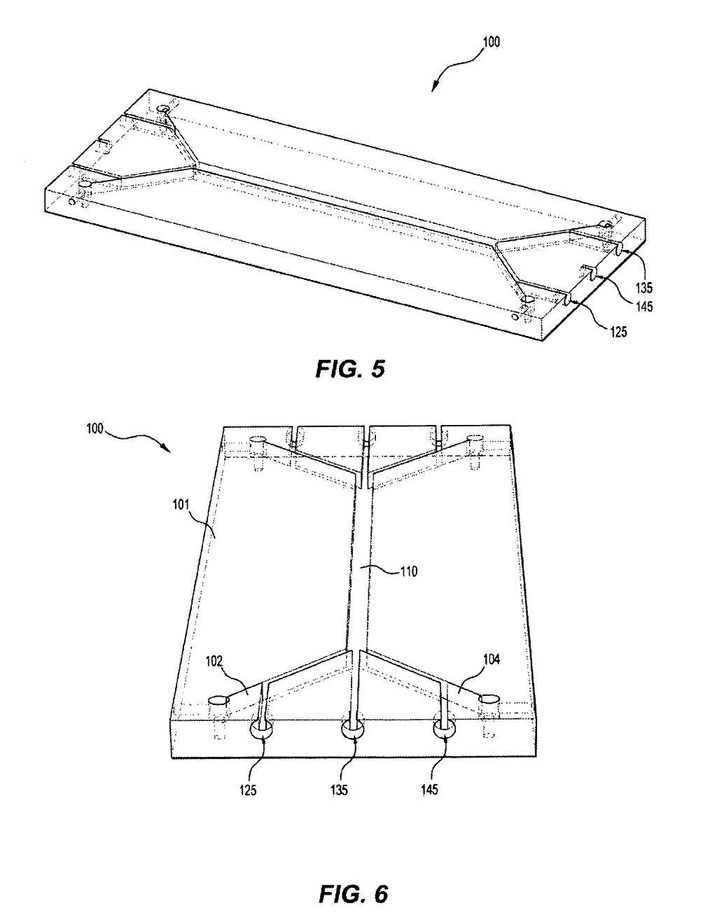

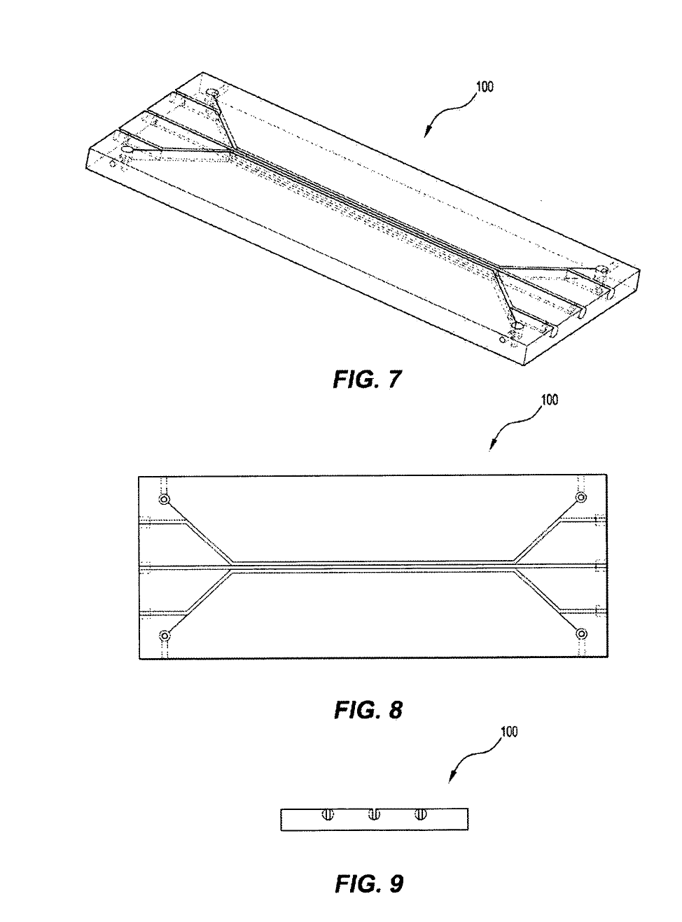

With an electrochemical cell configuration as described with reference to FIGS. 2 to 12, with three parallel laminar stream flows in a reaction channel 110 between two electrodes 102, 104, it is not necessary for ions to flow across a selective membrane. While not wanting to be bound by any one theory, the inventor believes the central neutralyte fluid 142 can act as a form of chemical capacitor, absorbing and supplying ions across the laminar fluid interfaces as required.

The neutralyte may comprise one or more metal oxide nano-particles. The inventor has conducted tests with a wide range of metal oxide nano-particles and all have been shown to be suitable for use in the present invention. The metal oxide nano-particles that have been tested include antimony oxides; mercury oxides; lead oxides; and silver oxides. The antimony oxide may comprise diantimony tetroxide; antimony trioxide; and/or antimony pentoxide. The mercury oxide may comprise mercury (I) oxide and/or mercury (II) oxide. The lead oxide may comprise lead (II) oxide PbO; lead (II,IV) oxide PB₃O₄; lead (IV) oxide PBO₂; lead (II,IV) oxide; Pb₂O₃; Pb₁₂O₁₉; and/or black lead oxide. The silver oxide may comprise Ag₂O; AgO; Ag₃O₄; Ag₂O₃; and/or Ag₄O₄.

In particular embodiment, neutralyte fluid 142 comprises nano-particles of an antimony oxide. For this purpose, a colloidal suspension of antimony-glass nano-particles has been found to be effective.

The term antimony glass is used because the particles are obtained through a process of vitrefication of antimony oxide.

The metal oxide nano-particles may comprise a particle size range between 10 micrometers and 1 nanometers. In a particular embodiment the size range comprises 1 micrometer to 10 nanometers.

The antimony-glass particles may comprise a spherical or substantially spherical shape with a peachoid cleft on the surface. By a peachoid cleft is meant a peach shaped of substantially peach shaped cleft.

FIGS. 4, 5 and 6 are various views illustrating a possible laminar flow electrochemical cell construction. The cell substrate 101 is of a non-conductive, non-reactive material such as, an appropriate polymer or ceramic. As will be described in the Examples below, a functional prototype has been constructed in epoxy acrylate material. The reaction channel 110 as well as the inlet 124, 134, 144 and outlet ports 126, 136, 146 can be formed in the substrate material through machining operations, or through chemical or laser ablation for example. Alternatively the substrate 101 could be moulded or formed by an additive manufacturing process. As seen in the drawings, the reaction channel and inlet/outlet ports comprise grooves or slots formed in the substrate. The reaction channel groove extends longitudinally, with the inlet ports 124, 134, 144 branching from one end thereof to separate inlet openings and the outlet ports 126, 136, 146 likewise branching from the other end to separate outlet openings. Formations are also provided for the electrodes 102, 104 extending along the channel sides to terminate at electrical connectors for coupling the cell 100 in an electrical circuit. The electrodes 102, 104 are made of a conductive material and should be suitably non-reactive with the electrolytes. Gold foil can be used, for example.

In the cell construction as shown, channel 110 and ports 124, 126, 134, 136, 144, 146 are open at the upper face of the substrate 101 which requires that a cover be placed on top to enclose the slot formations. A flat piece of the same substrate material can be used for that purpose, and in an array of cells 100 (described hereinbelow) the upper cover for one cell substrate may comprise the under-surface of another cell substrate bonded or mechanically affixed on top.

The electrolyte fluids enter and leave the electrochemical cell through the inlet openings and outlet openings. The cell 100 is symmetrically formed in the substrate with respect to the longitudinal and lateral axes so that the inlet 124, 134, 136 and outlet 126, 136, 146 ports and the negative 102 and positive 104 electrodes are functionally interchangeable depending on the cell orientation.

Since cell 100 operates through the use of parallel laminar fluid streams in reaction channel 110, the dimensions of channel 110 relative to the fluid properties can have an effect on operation. In a particular circumstance an indicator of the conditions for laminar fluid flow is a low value of Reynolds number, which is related to the channel dimensions and the fluid characteristics. For a given fluid a narrower channel will promote laminar flow. To achieve laminar flow streams using the type of fluids contemplated in this application, channel width and/or depth dimensions of the millimeter order or smaller are appropriate. Thus, the electrochemical cell 100 may be considered a micro-fluidic device.

Electrolyte fluid flow rates through each cell 100 are small because of the narrow channel 110 dimensions. In the prototype cell 100 a flow rate of about 0.1 ml per minute is used. A flow battery 10 employing such a cell 100 with an electrolyte reservoir size of about 40 ml can therefore achieve a discharge duration of around 6 hours.

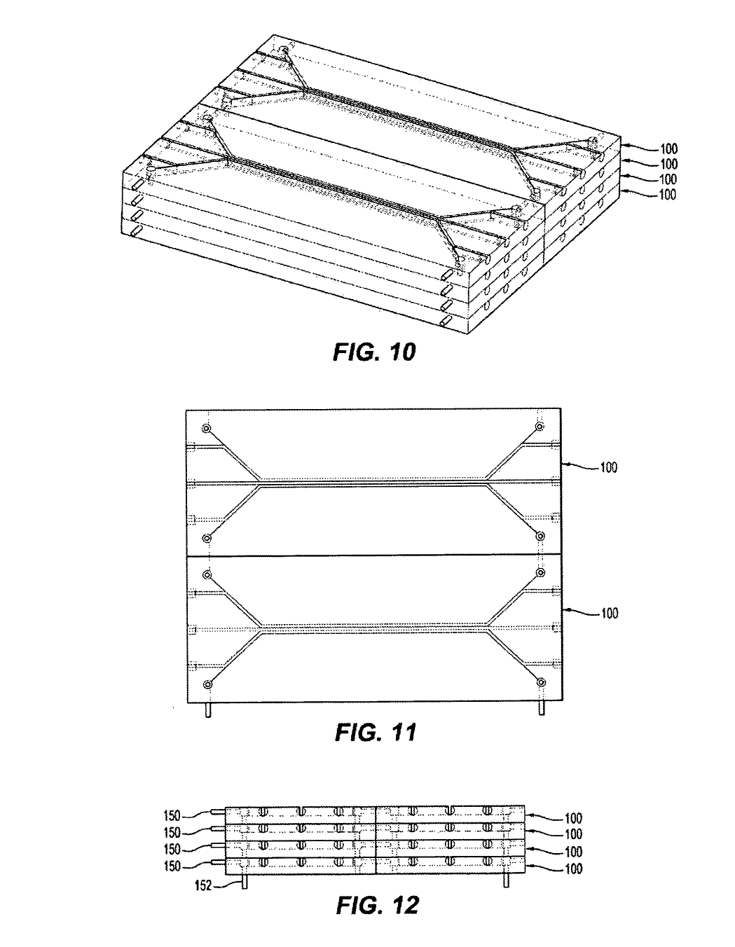

To construct a flow battery 10 from micro-fluidic laminar flow electrochemical cells 100 it is useful to have a plurality of cells 100 coupled together to obtain desired electrical output voltage and current characteristics. The electrical terminals of the cells 100 can be connected in series or parallel, or in a combination of series and parallel connections. On the other hand, the fluid circuits 120, 130, 140 carrying the electrolytes between the reservoirs 121, 131, 141 and cells 100 are best arranged in parallel to minimise overall resistance to fluid flow through the narrow channels 110. An arrangement of a plurality of cells 100 is shown in FIGS. 10, 11 and 12. Electrical connections can be made as appropriate with adjacent cells 100 through the electrical connectors to form series 150 and/or parallel 152 circuits (see FIG. 12). Fluid connections from the reservoirs 121, 131, 141 (not shown in FIGS. 10 to 12) to the inlet 124, 134, 144 and outlet 126, 136, 146 openings of the multiple cells 100 can be made using individual conduits, or through fluid manifolds attached to the ends of the cell stacks.

A prototype battery 10 has been designed to employ substrate 101 wafers 100 mm×100 mm×2 mm thick. Each such substrate 101 wafer contains eight electrochemical cells 100 electrically connected in series. To obtain voltage and current characteristics roughly equivalent to a car battery, 20 wafers can be connected in parallel to produce about 13 amps electrical output. The wafer stack is then surrounded by three storage reservoirs 121, 131, 141 each holding 200 ml of respective electrolyte fluid 122, 132, 142 and coupled to the cells 100 through electronically controlled pumps to ensure optimum flow of electrolytes to the cells 100, monitoring of temperature, back-pressure, pH and other relevant parameters to ensure consistent, safe production and storage of energy.

The invention also provides a method for manufacturing an electrochemical cell 100. The method comprises a step of providing a substrate 101 with an elongate channel 110 formed therein. The method also comprises the step of extending first 102 and second 104 electrodes longitudinally in the channel 110 so as to be disposed to opposite sides of the channel 110. Further comprised in the method is the step of providing three fluid ports at each end of the channel for ingress and egress of respective fluids, wherein three fluids entering into the channel through respective fluid ports at one end flow through the channel in parallel laminar streams and exit the channel through the respective ports at the other end.

As mentioned above, the flow battery 10 of the invention may be used in an electric vehicle. The flow battery 10 may be inserted into an electric vehicle using conventional installation techniques. As such, the invention also provides a method of powering an electric vehicle comprising providing one or more flow batteries 10 to thereby provide the power for the electric vehicle.

So that the invention may be readily understood and put into practical effect, the following non-limiting Examples are provided.

### EXAMPLES

### Example 1

### Antimony Oxide

A laboratory within the Melbourne Center for Nanofabrication (MCN), the PDMS (Polydimethylsiloxane) laboratory was used for electrochemical testing of a cell according to the invention. The PDMS lab complies with all relevant Australian standards. The performance for voltage and amperage under load of a single reaction cell of the flow battery of the invention was tested.

The required instruments and equipment to conduct the test consisted of dual syringe pumps, a single self priming Bartel micro diaphragm pump, a bioccular zoom microscope, electrical multimeter, a 0.5 amp pulsing red LED light to indicate that at least 0.5 of an amp was being produced, ready prepared vanadium electrolytes redox pairs, and prepared proprietary EDEN Glass nano-particles in colloidal suspension of deionized water. The EDEN Glass nano-particles were manufactured using an antimony oxide by Eden BDM Limited. Eden BDM Limited have an office located at Suite 35, 199 Toorak Road, South Yarra, 3141 and a laboratory at the MCN, 151 Wellington Road, Clayton, 3168 both in Victoria, Australia. Eden BDM Limited have a website, www.edenbdm.com, and can be emailed using info@edenbdm.com or telephoned using the number +61 1300 131 831.

### Cell:

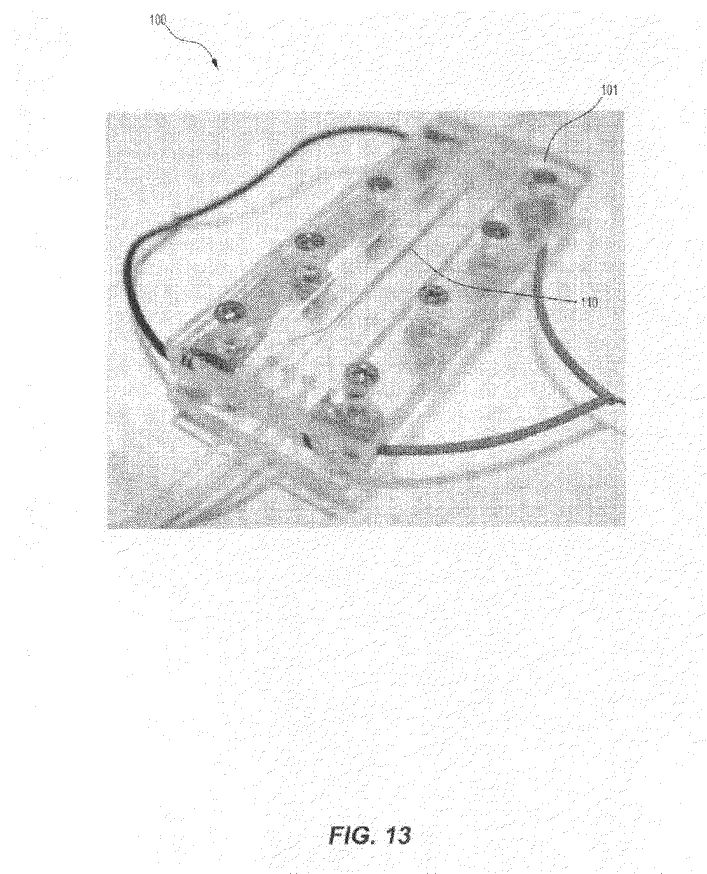

The physical construction of the cell chip was made on an Eden 260 3D printer using transparent Fullcure 720 epoxy acrylate. The sample followed an autocad design in STL format. The finished samples required water blasting and chemical solvents to clean out the construction plastics to give a clean, finished product. A sample top was constructed from clear acrylic sheet with a gasket of PDMS to seal the two halves of the cell. Several bolts were required to hold the device in place. FIG. 13 shows an assembled cell 100.

The cell being constructed from transparent materials allows direct viewing of the electrolyte reactions in the cell channels, both under a microscope and with the naked eye.

The electrodes used comprised fine 24 karat gold ribbon and were 0.2 mm thick×0.6 mm wide. The ribbon was attached along the channel length and tightened to electrode studs built into the design for the purpose. The gold ribbon was first sputtered with gold nano-particles of 10 nm in diameter to increase surface area of the electrodes. The electrode were tensioned along the side walls of the channel, free floating (not glued) to allow full contact with electrolytes on both sides.

The gold ribbon extended from the interior of the cell to wrap around the external studs. These are encased in copper tape to form a durable connection for electrical supply and current collection. Insulated copper wire was then soldered to the copper studs to allow for external connection.

### Electrolytes:

The solutions contain various strengths of vanadium species in redox pairs. The four main chemicals are VO+2, V₂O₃+3; VO₂+4; and V₂O₅+5. The test used sulphuric acid at 3M strength with supersaturated solutions of the vanadium +5 and +3 species. The state of oxidation of the redox pairs determines the electrical current potential, to that end the four electrolytes made started from the +5 level and reduced with reducing agents through to the +4, +3, +2 forms. These are colours, yellow, blue, green and lavender. The redox pairs were arranged in the cell so as to create maximum electrical potential for a battery cell. +5 and +4 make the cathode with +3 and +2 make up the anode side of the circuit.

### Metal Oxide Nano-Particles:

This central flow electrolyte replaces the ion exchange membrane found in vanadium flow batteries. Three fluids flow through a micro channel achieving strong laminar flow with no visible turbulence. Nano-particles were added to deionized water and immediately coalesced into a colloidal suspension. This was a clear, colourless, odourless fluid. These particles are described as nano-sized capacitors due to their effect of collecting charge. While not wanting to be bound by any one theory, the inventor hypothesises that the nano-particles are thought to attract charged ions, store them in the surface skin and have them available on demand. The flow of ions in the cycles triggers the nano-particles to release the ions and contribute to the current increase.

The average size of the nano-particles was 1 micron down to 10 nm. The shape of the nano-particles was spherical with a “peachoid” cleft on the surface. This distinguishing shape may be unique to the nano-particles of the invention and may be used to clearly identify them for this product.

The nano-particles are described as being the final product of vitrification of metal oxides in a proprietary process.

### Method:

The EDEN nanoflow cell was connected electrically with a positive and negative lead running from the cell electrodes to the multimeter. The cell was positioned under the zoom microscope to facilitate viewing of the electrolytes passing through the cell and into the respective storage tanks. The vanadium electrolytes were pumped from 100 ml plastic syringes mounted in the syringe pump, through a 1.3 mm diameter silicon tube to ports in the cell. The flow rate of the vanadium electrolytes was 0.1 ml per minute or 6 ml per hour.

The first measurement taken was an open circuit voltage reading with no load discharge or charge being delivered. The inherent charge contained in the electrolytes for standard vanadium solutions is 1.2 to 1.5 volts, regardless of battery architecture. Once the vanadium electrolytes were flowing, the third central nano-particle fluid was added at the same flow rate. A multimeter reading was taken at east stage and results recorded.

### Results:

The voltage from the stationary cell, full of electrolytes but with no flow was 0.82 volts. Once the two vanadium electrolytes were pumped into the cell, the voltage jumped to 1.2 to 1.5 volts, fluctuating over a time period of 30 seconds.

The third nano-particle fluid was added and the voltage jumped to 4.8 volts initially, fluctuating from 4.6 to 5.2 volts over a further 30 seconds, before steadying to 5 volts.

This test was repeated several times for increasing durations of time with the final test running continuously for 3 hours.

Similarly, the LED was added to the circuit and the multimeter settings changed to read amperage. The amperage produced ranged from 0.45 to 0.6 of one amp over the 3 hour period.

The LED light flash pulsed continuously indicating that the current was enough to power this load. The fluctuation in the current result is thought to be from the freshly made vanadium electrolyte. This issue occurs in a lab condition where small amounts of new electrolyte are made as needed. In a standardized manufacturing process this would not occur as the electrolytes are made and supplied in bulk.

The bench top test ran smoothly for the 3 hour test duration. No electrolyte leaks or equipment failure occurred. The digital display on the multimeter was recorded by video for the duration and to record the results.

### Conclusion

The present invention describes a miniature vanadium flow battery utilising a metal oxide nano-particle electrolyte that substantially increases the performance of a standard flow battery. Three fluids pass down a micro-channel with dimensions of 100 microns wide by 400 microns deep. The microfluid technology was housed in a reaction cell of a single plastic chip.

The projected prototype battery architecture will comprise 168 chips connected in series or parallel, along with storage tanks for electrolytes, electronic controller and micropumps for circulation. Logic suggests that when the 168 cells are connected, the prototype battery should meet the projected specifications described by the Patent Owner of 800 V and 80 Amps, depending on the configuration.

### Example 2

### Nano-Particles of Other Metal Oxides

As noted above, similar successful trials have been conducted with metal oxide nano-particles comprising a mercury oxide; a lead oxide and a silver oxide.

The foregoing description of a laminar flow electrochemical cell and flow battery has been presented by way of example only, and many variations to the features described are possible without departing from the essence of the invention.

1.-16. (canceled)

17. An electrochemical cell comprising:
a substrate with an elongate channel formed therein;
first and second electrodes extending longitudinally in the channel and disposed to opposite sides thereof; and
three fluid ports at each end of the channel for ingress and egress of respective fluids, wherein three fluids entering into the channel through respective fluid ports at one end flow through the channel in parallel laminar streams and exit the channel through the respective ports at the other end.

18. The electrochemical cell of claim 17, wherein the third fluid comprises a neutralyte.

19. The electrochemical cell of claim 18, wherein the neutralyte comprises one or more metal oxide nano-particles.

20. The electrochemical cell of claim 19, wherein the one or more metal oxide nano-particles comprise one or more nano-particles from the group consisting of: antimony oxide nano-particles, mercury oxide nano-particles, lead oxide nano-particles, and silver oxide nano-particles.

21. The electrochemical cell of claim 19, wherein the one or more metal oxide nano-particles comprises antimony oxide nano-particles.

22. The electrochemical cell of claim 17, wherein the third fluid comprises a colloid suspension of one or more metal oxide nano-particles.

23. The electrochemical cell of claim 17, wherein the one or more metal oxide nano-particles comprise a particle size in a range between 10 micrometers and 1 nanometer or between 1 micrometer and 10 nanometers.

24. The electrochemical cell of claim 17, wherein the one or more metal oxide nano-particles have a spherical or substantially spherical shape with a peachoid cleft on a surface thereof.

25. The electrochemical cell of claim 17, wherein the one or more metal oxide nano-particles comprise vitrified nano-particles.

26. A flow battery comprising:
at least one electrochemical cell comprising:
a substrate with an elongate channel formed therein;
first and second electrodes extending longitudinally in the channel and disposed to opposite sides thereof; and
three fluid ports at each end of the channel for ingress and egress of respective fluids, wherein three fluids entering into the channel through respective fluid ports at one end flow through the channel in parallel laminar streams and exit the channel through the respective ports at the other end;
three fluid reservoirs coupled to the respective ports at one end of the channel to provide fluids thereto; and
at least one fluid motivator arranged to drive fluids from the reservoirs into the channel through the respective ports.

27. The flow battery of claim 26, wherein the third fluid comprises a neutralyte.

28. The flow battery of claim 27, wherein the neutralyte comprises one or more metal oxide nano-particles.

29. The flow battery of claim 28, wherein the one or more metal oxide nano-particles comprise one or more of nano-particles from the group consisting of: antimony oxide nano-particles, mercury oxide nano-particles, lead oxide nano-particles, and silver oxide nano-particles.

30. The flow battery of claim 28, wherein the one or more metal, oxide nano-particles comprise antimony oxide nano-particles.

31. A method for manufacturing an electrochemical cell comprising:
providing a substrate with an elongate channel formed therein;
extending first and second electrodes longitudinally in the channel so as to be disposed to opposite sides of the channel; and
providing three fluid ports at each end of the channel for ingress and egress of respective fluids, wherein three fluids entering into the channel through respective fluid ports at one end flow through the channel in parallel laminar streams and exit the channel through the respective ports at the other end.

32. The method of claim 31, wherein the third fluid comprises a neutralyte.

33. The method of claim 32, wherein the neutralyte comprises one or more metal oxide nano-particles.

34. An electric vehicle comprising at least one flow battery of claim 26.

35. A method of powering an electric vehicle comprising:
providing at least one flow battery of claim 26 to provide power for the electric vehicle.

36. A method for assembling an electric vehicle and an electric power source comprising:
inserting at least one flow battery of claim 26 into the electric vehicle to provide the electric power source.
